(19) United States
(12) Patent Application Publication
(10) Pub. No.: US 2016/0233940 A1
(43) Pub. Date: Aug. 11, 2016

(54) WIRELESS DEVICE, METHOD, AND COMPUTER READABLE MEDIA FOR SPATIAL REUSE IN A HIGH EFFICIENCY WIRELESS LOCAL-AREA NETWORK

(71) Applicants: Po-Kai Huang, West Lafayette, IN (US); Qinghua Li, San Ramon, CA (US); Robert J. Stacey, Portland, OR (US); Rongzhen Yang, Shanghai (CN)

(72) Inventors: Po-Kai Huang, West Lafayette, IN (US); Qinghua Li, San Ramon, CA (US); Robert J. Stacey, Portland, OR (US); Rongzhen Yang, Shanghai (CN)

(21) Appl. No.: 14/747,224

(22) Filed: Jun. 23, 2015

Related U.S. Application Data
(60) Provisional application No. 62/113,040, filed on Feb. 6, 2015.

(51) Int. Cl. H04B 7/06; H04W 72/08; H04B 7/04; H04L 27/26; H04W 76/02

(52) U.S. Cl. CPC H04B 7/0697; H04L 27/26; H04W 76/025; H04B 7/0452; H04W 72/082; H04W 84/12

(57) ABSTRACT

Wireless devices, methods and computer readable media for spatial reuse in a high efficiency wireless local-area network. An apparatus of a HEW station may comprise circuitry. The circuitry may be configured to determine if a plurality of links with a plurality of wireless stations are device-to-device links that indicate that there is a spatial reuse opportunity; and transmit a packet that comprises a spatial reuse indication that there is the spatial reuse opportunity, if the spatial reuse opportunity is indicated. The spatial reuse opportunity may be an uplink orthogonal frequency division multiple access (OFDMA) with the plurality of wireless stations, a downlink OFDMA with the plurality of wireless stations, or a downlink multiple users multiple-input multiple-output (MU-MIMO). The spatial reuse indication may include a margin that indicates how a second HEW station may adjust a transmit power and clear channel assessment to use within the spatial opportunity.

### PRIORITY CLAIM

This application claims the benefit of priority under 35 USC 119(e) to U.S. Provisional Patent Application Ser. No. 62/113,040, filed Feb. 6, 2015, which is incorporated herein by reference in its entirety.

### TECHNICAL FIELD

Embodiments pertain to wireless communications in a wireless local-area network (WLAN). Some embodiments relate to spatial reuse for device-to-device (D2D) communication. Some embodiments relate to Institute of Electrical and Electronic Engineers (IEEE) 802.11 and some embodiments relate to IEEE 802.11 ax. Some embodiments relate to a transmitter using uplink or downlink OFDMA and/or MU-MIMO signaling information to enable another transmitter to spatially reuse the wireless medium. Some embodiments relate to a transmitter determining a spatial reuse opportunity and adjusting parameters to enable spatial reuse.

### BACKGROUND

Users of wireless networks often demand more bandwidth and faster response times. However, the available bandwidth may be limited. One issue in wireless local area networks (WLANs) is that the wireless devices may be close to each other and operating with different master stations or access points (APs). As wireless communication has become more and more popular there are more and more devices operating close to one another.

Thus, there are general needs for systems and methods for efficiently using the wireless medium, and in particularly, using the wireless medium when wireless devices may be close to one another.

### BRIEF DESCRIPTION OF THE DRAWINGS

FIG. 1 illustrates a WLAN in accordance with some embodiments;

FIG. 2 illustrates a method of determining interference in accordance with some embodiments;

FIG. 3 illustrates a method of determining interference in accordance with some embodiments;

FIG. 4 illustrates a method for spatial reuse for device-to-device links in accordance with some embodiments;

FIG. 5 illustrates a frame for a wireless device to send a spatial reuse indication 506 in accordance with some embodiments;

FIG. 6 illustrates an exchange where a frame may include a spatial reuse indication in accordance with some embodiments;

FIG. 7 illustrates an exchange where a frame may include a spatial reuse indication in accordance with some embodiments;

FIG. 8 illustrates a spatial reuse indication that comprises a margin field in accordance with some embodiments;

FIG. 9 illustrates a margin field that includes additional interference subfield, current interference level subfield, and TX power subfield;

FIG. 10 illustrates a margin field that includes tolerable interference level subfield and TX power 1004 subfield;

FIG. 11 illustrates a margin field that includes a tolerable interference level plus TX power subfield;

FIG. 12 illustrates the margin as an additional interference above an average interference level;

FIG. 13 illustrates the margin as a tolerable interference level above a base threshold;

FIG. 14 illustrates a TX wireless device with three RX wireless devices linked to the TX wireless device in accordance with some embodiments;

FIG. 15 illustrates a method of spatial reuse in accordance with some embodiments;

FIG. 16 illustrates a method for uplink spatial reuse in accordance with some embodiments;

FIG. 17 illustrates an example where a receiver may identify the D2D links in accordance with some embodiments;

FIG. 18 illustrates a method for uplink spatial reuse in accordance with some embodiments;

FIG. 19 illustrates two links in accordance with some embodiments;

FIG. 20 illustrates the two links illustrated in FIG. 19 with signal strengths in accordance with some embodiments;

FIG. 21 illustrates a HEW device in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

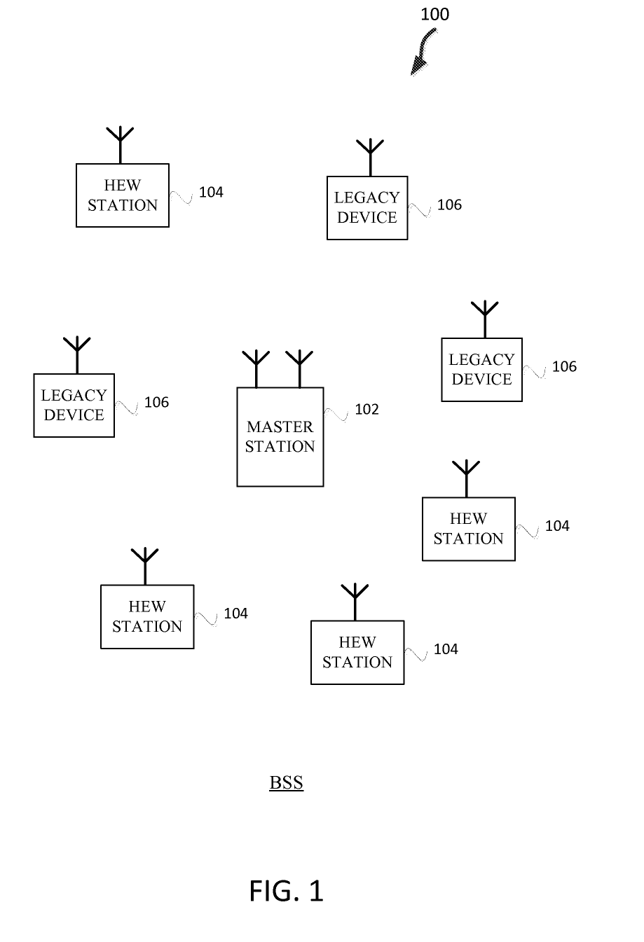

FIG. 1 illustrates a WLAN 100 in accordance with some embodiments. The WLAN may comprise a basis service set (BSS) 100 that may include a master station 102, which may be an AP, a plurality of high-efficiency wireless (HEW) (e.g., IEEE 802.1 lax) STAs 104 and a plurality of legacy (e.g., IEEE 802.11n/ac) devices 106.

The master station 102 may be an AP using the IEEE 802.11 to transmit and receive. The master station 102 may be a base station. The master station 102 may use other communications protocols as well as the IEEE 802.11 protocol. The IEEE 802.11 protocol may be IEEE 802.11ax. The IEEE 802.11 protocol may include using OFDMA, time division multiple access (TDMA), and/or code division multiple access (CDMA). The IEEE 802.11 protocol may include a multiple access technique. For example, the IEEE 802.11 protocol may include space-division multiple access (SDMA) and/or MU-MIMO.

The legacy devices 106 may operate in accordance with one or more of IEEE 802.11 a/g/ag/n/ac, IEEE 802.11-2012, or another legacy wireless communication standard. The legacy devices 106 may be STAs or IEEE STAs.

The HEW STAs 104 may be wireless transmit and receive devices such as cellular telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HEW STAs 104 may be termed high efficiency (HE) stations.

The BSS 100 may operate on a primary channel and one or more secondary channels or sub-channels. The BSS 100 may include one or more master stations 102. In accordance with some embodiments, the master station 102 may communicate with one or more of the HEW devices 104 on one or more of the secondary channels or sub-channels or the primary channel. In accordance with some embodiments, the master station 102 communicates with the legacy devices 106 on the primary channel. In accordance with some embodiments, the master station 102 may be configured to communicate concurrently with one or more of the HEW STAs 104 on one or more of the secondary channels and a legacy device 106 utilizing only the primary channel and not utilizing any of the secondary channels.

The master station 102 may communicate with legacy devices 106 in accordance with legacy IEEE 802.11 communication techniques. In example embodiments, the master station 102 may also be configured to communicate with HEW STAs 104 in accordance with legacy IEEE 802.11 communication techniques. Legacy IEEE 802.11 communication techniques may refer to any IEEE 802.11 communication technique prior to IEEE 802.11 ax.

In some embodiments, a HEW frame may be configurable to have the same bandwidth as a sub-channel, and the bandwidth may be one of 20 MHz, 40 MHz, or 80 MHz, 160 MHz, 320 MHz contiguous bandwidths or an 80+80 MHz (160 MHz) non-contiguous bandwidth. In some embodiments, bandwidths of 1 MHz, 1.25 MHz, 2.0 MHz, 2.5 MHz, 5 MHz and 10 MHz, or a combination thereof or another bandwidth that is less or equal to the available bandwidth, may also be used. A HEW frame may be configured for transmitting a number of spatial streams, which may be in accordance with MU-MIMO.

In other embodiments, the master station 102, HEW STA 104, and/or legacy device 106 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HEW communications. In accordance with some IEEE 802.11 ax embodiments, a master station 102 may operate as a master station which may be arranged to contend for a wireless medium (e.g., during a contention period) to receive exclusive control of the medium for an HEW control period. In some embodiments, the HEW control period may be termed a transmission opportunity (TXOP). The master station 102 may transmit a HEW master-sync transmission, which may be a trigger frame or HEW control and schedule transmission, at the beginning of the HEW control period. The master station 102 may transmit a time duration of the TXOP and sub-channel information. During the HEW control period, HEW STAs 104 may communicate with the master station 102 in accordance with a non-contention based multiple access technique such as OFDMA or MU-MIMO. This is unlike conventional WLAN communications in which devices communicate in accordance with a contention-based communication technique, rather than a multiple access technique. During the HEW control period, the master station 102 may communicate with HEW stations 104 using one or more HEW frames. During the HEW control period, the HEW STAs 104 may operate on a sub-channel smaller than the operating range of the master station 102. During the HEW control period, legacy stations refrain from communicating. In accordance with some embodiments, during the master-sync transmission the HEW STAs 104 may contend for the wireless medium with the legacy devices 106 being excluded from contending for the wireless medium during the master-sync transmission.

In some embodiments, the multiple-access technique used during the HEW control period may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station 102 may also communicate with legacy stations 106 and/or HEW stations 104 in accordance with legacy IEEE 802.11 communication techniques. In some embodiments, the master station 102 may also be configurable to communicate with HEW stations 104 outside the HEW control period in accordance with legacy IEEE 802.11 communication techniques, although this is not a requirement.

In example embodiments, the HEW device and/or the master station 102 are configured to perform the methods and functions described in conjunction with FIGS. 1-21 and disclosed herein such as generating, transmitting, receiving, and operating in accordance with signaling for a spatial reuse.

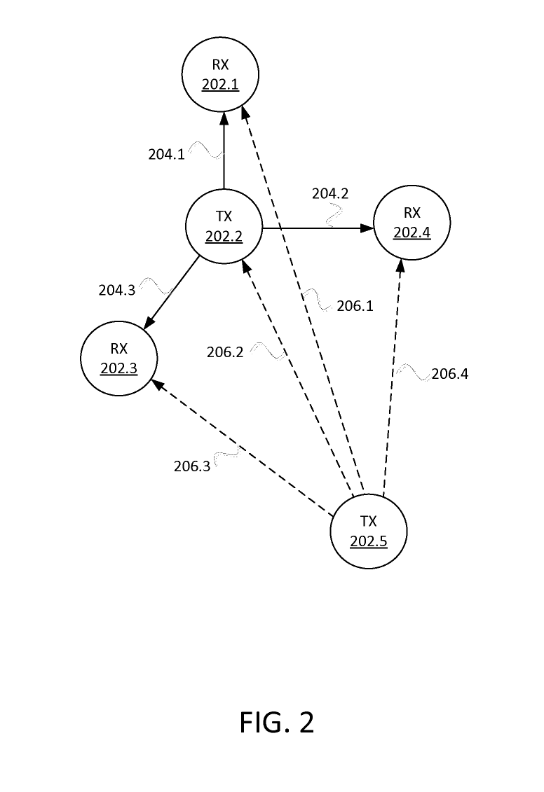

FIG. 2 illustrates a method of determining interference in accordance with some embodiments. Illustrated in FIG. 2 are wireless devices 202, links 204, and interference 206. The wireless devices 202.1 (RX), 202.2 (TX), 202.3 (RX), 202.4 (RX), and 202.5 (TX), may be an AP 102, HEW device 104, and/or a legacy device 106. RX is an abbreviation for receiver, and TX is an abbreviation for transmitter. Link 204 may be D2D links.

Wireless device 202.2 may be a transmitting wireless device that is linked with wireless devices 202.1, 202.2, and 202.3. Link 204.1 is between wireless device 202.2 and wireless device 202.1. Link 204.2 is between wireless device 202.2 and wireless device 202.4. Link 204.3 is between wireless device 202.2 and wireless device 202.3.

Interference 206.1, 206.2, 206.3, and 206.4 are the interferences that wireless device 202.5 would cause to the wireless device 202.1, 202.2, 202.3, and 202.4, respectively, if wireless device 202.5 transmits. For example, if wireless device 202.5 transmits then interference 206.3 is the interference the transmission will cause to wireless device 202.3.

In some embodiments the wireless devices 202, which may be an AP 102 and/or HEW device 104, are configured to approximate the interferences 206.4, 206.1, and 206.3 with the interference 206.2. In some embodiments the wireless devices 202 may approximate the interference 206 to a device linked 204 to another device by the interference 206 to the wireless device 202 it is linked to. For example, wireless device 202.5 may be configured to approximate the interference 206.1 that wireless device 202.5 will cause to wireless device 202.1 by the interference 206.2 that wireless device 202.5 will cause to wireless device 202.2.

In some embodiments the wireless devices 202, which may be an AP 102 and/or HEW device 104, are configured to assume that all transmissions are OFDMA/MU-MIMO transmissions in both the uplink (UL) and downlink (DL) to simplify the interference measurements.

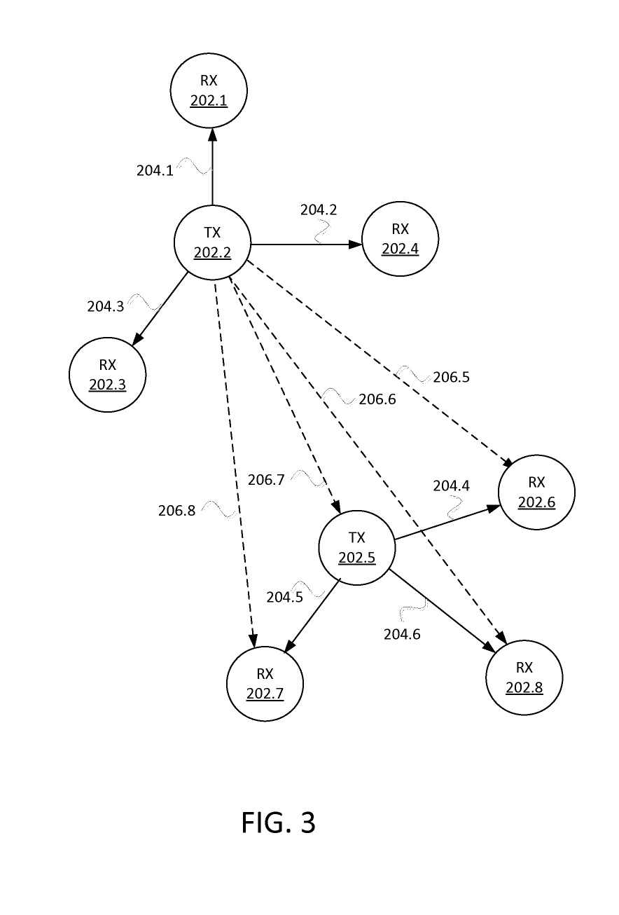

FIG. 3 illustrates a method of determining interference in accordance with some embodiments. Illustrated in FIG. 3 are wireless devices 202, links 204, and interference 206. The wireless devices 202.6 (RX), 202.7 (RX), 202.8 (RX) are new compared with FIG. 2. Wireless devices 202.6, 202.7, 202.8 are linked 202.4, 202.5, 202.6, respectively, with wireless device 202.5.

Wireless device 202.5 may measure interference 206.7. Wireless device 202.5 may approximate the interference 206.2 (FIG. 2) caused by wireless device 202.5 to wireless device 202.2 by interference 206.7. The approximation of interference 206.2 by interference 206.7 may be determined more accurately if wireless device 202.5 knows the power that wireless device 202.2 used to transmit interference 206.7. Wireless device 202.5 may then approximate the interference 206 to wireless device 202.3, 202.2, 202.4 that are linked 204 to wireless device 202.2 by the approximation of interference 206.2 by interference 206.7. Wireless device 202.5 may approximate interference 206.2 by interference 206.7 and margin signaling from wireless device 202.2. In some embodiments wireless device 202.5 may approximate interference 206.2 by interference 206.7 and reduction value of power control.

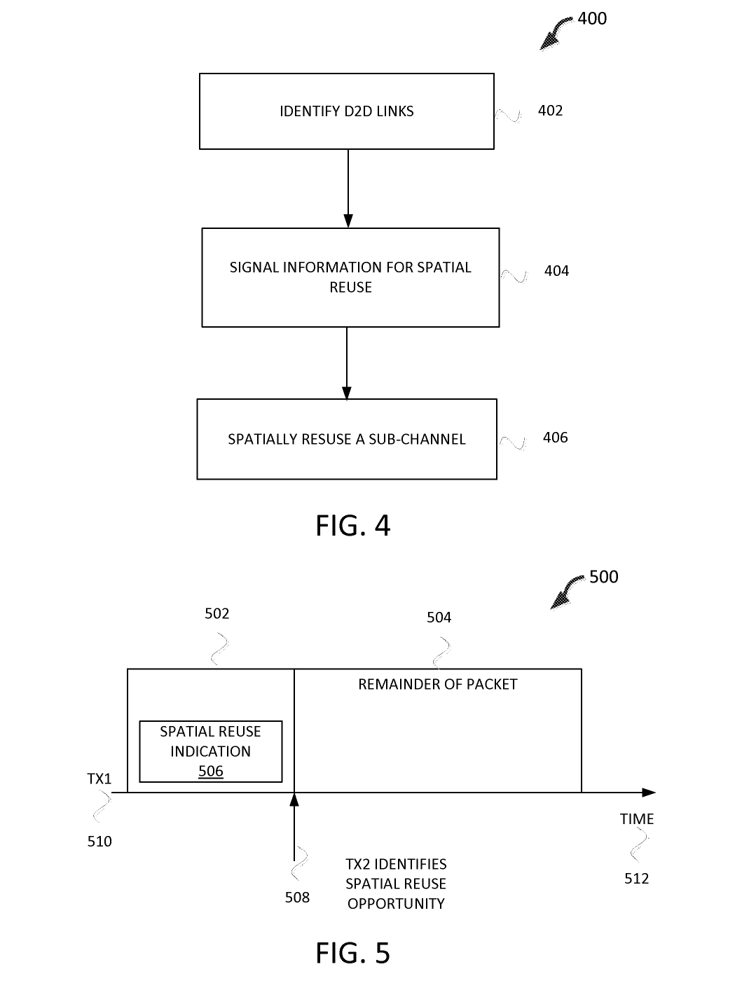

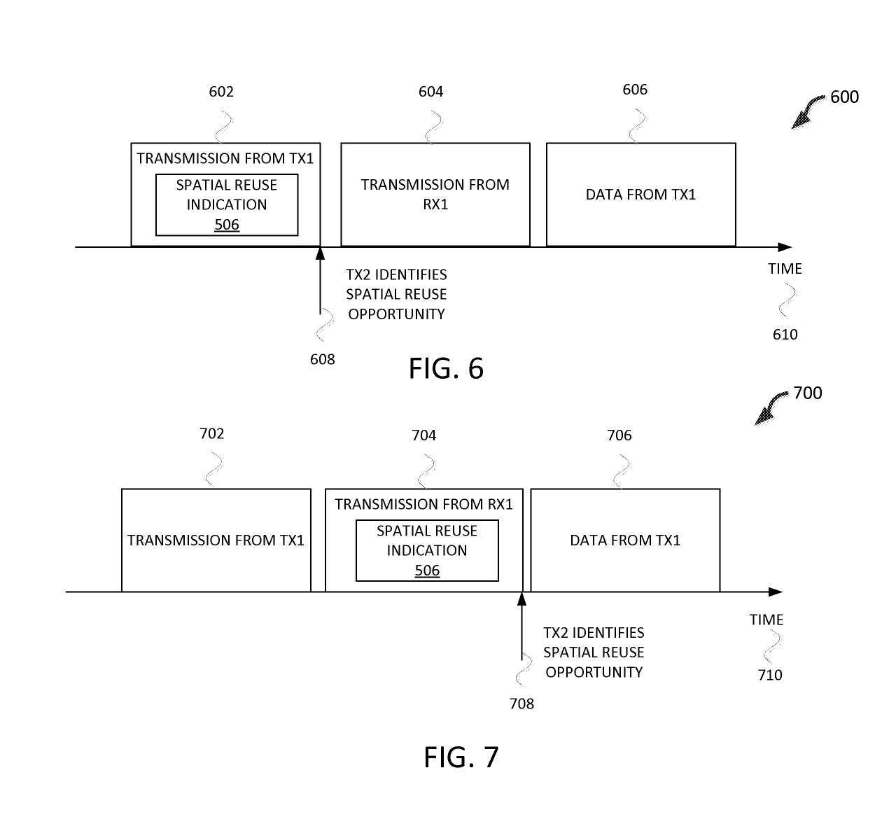

FIG. 4 illustrates a method 400 for spatial reuse for device-to-device links in accordance with some embodiments. FIG. 4 will be described in conjunction with FIGS. 5-15. FIGS. 6 and 7 illustrate margins 602, 702 in accordance with some embodiments.

The method begins at operation 402 with identify D2D links. D2D links are identified so that another link can potentially spatially reuse the same or an overlapping sub-channel or channel. The transmitter (TX) such as wireless device 202.2 (FIGS. 2 and 3) may determine whether or not link 204.2 is a D2D link with wireless device 202.4.

If the signal strength is high such as −36 dBm to −44 dBm for 1 meter to 3 meter distance, then the signal strength may be determined to be high. For example, the link 204.2 may be a D2D link. In some embodiments, a threshold value for signal strength is determined, and if the signal strength is higher than the threshold value, then the wireless device 202 may identify the link 204 as a D2D link.

In some embodiments, the wireless device 202 such as 202.4 measures the received signal strength and compares it with the threshold. If the signal strength is higher than the threshold, then the wireless device 202 may send this information to the wireless device 202 that transmitted the signal. For example, wireless device 202.4 may receive a transmission over link1 204.2 from wireless device 202.2. Wireless device 202.4 may measure the signal strength of the transmission and compare the signal strength with a threshold value. The wireless device 202.4 may then send a packet to the wireless device 202.2 that indicates that link 204.2 is a D2D link. For example, the wireless device 202.4 may indicate the link 204.2 is a D2D link with one bit in a field that may be unused in a frame such as an acknowledgement frame, a block acknowledgement frame, a clear-to-send frame, a control frame, or a management frame.

In some embodiments, the wireless device 202.2 may receive information regarding the signal strength of a transmission sent to another wireless device 202 such as 202.4 using link 204.2. For example, the wireless device 202.4 may send the wireless device 202.2 a link measurement report regarding transmission over link 204.2 The wireless device 202.2 may have a threshold for the link margin, and if the link margin is greater than the threshold determine that the link 204.2 is a D2D link.

In some embodiments, a TX wireless device such as wireless device 202.2 may determine whether the link 204.2 is a D2D link based on the signal strength of feedback from a RX wireless device such as wireless device 202.4. To determine the signal strength, the wireless device 202.2 needs the transmitting power used by the wireless device 202.4. The wireless device 202.2 may receive the transmitting power used by the wireless device 202.4 from a report from the wireless device 202.4 such as a transmitter power control (TPC) report element in an action frame. In some embodiments the wireless device 202.2 or wireless device 202.4 may identify more than one link 204 as a D2D link.

The method 400 may continue at operation 404 with signal a spatial reuse indication in accordance with some embodiments. Operation 404 will be described in conjunction with FIGS. 5-7.

FIG. 5 illustrates a frame 500 for a wireless device 202 to send a spatial reuse indication 506 in accordance with some embodiments. Illustrated in FIG. 5 is packet 500. Time 512 is along the horizontal axis. The TX1 510 is a wireless device 202 that transmits packet 500. TX2 identifies spatial reuse opportunity 508. The packet 500 includes a first portion 502 that may be a preamble or MAC header 502 and remainder of packet 504. The first portion 502 may include the spatial reuse indication 506. The spatial reuse indication 506 may be part of a HE-SIG and/or a MAC header 502. The spatial reuse indication 506 may be part of a HE-SIG-A, HE-SIG-B, and/or HE-SIG-C. The spatial reuse indication 506 may be a one bit signal that there is a spatial reuse opportunity. In some embodiments the spatial reuse indication 506 may be in a physical layer portion of the packet 500. In some embodiments the spatial reuse indication 506 may use a margin field to indicate that a spatial reuse opportunity is available. For example, in some embodiments, the wireless device 202.2 may indicate a spatial opportunity is available if a margin field is greater than zero. The TX2 may be a wireless device 202. AT time 508 TX2 may identify the spatial reuse opportunity after receiving the spatial reuse indication 506.

An example of operation 404 is a TX wireless device such as wireless device 202.2 signaling a spatial reuse indication 506 (FIG. 5) in a first portion of a packet that is received by wireless device 202.5. The wireless device 202 may also signal information for spatial reuse in a separate frame exchange as described in FIGS. 6 and 7.

FIG. 6 illustrates an exchange 600 where a frame 602 may include a spatial reuse indication 506 in accordance with some embodiments. Illustrated in FIG. 6 is time 610 along a horizontal axis and frames 702, 704, and 706. Frames 602 and 604 are transmitted by TX1 and frame 604 is transmitted by RX1. TX1 and RX1 are wireless devices 202. TX1 may send a spatial reuse indication 506 in frame 602. For example, wireless device 202.2 or 202.4 may exchange a frame with wireless device 202.5 that includes the spatial reuse indication 506. The TX2 may be a wireless device 202. At time 608 TX2 may identify the spatial reuse opportunity after receiving the spatial reuse indication 506.

FIG. 7 illustrates an exchange 700 where a frame 704 may include a spatial reuse indication 506 in accordance with some embodiments. Illustrated in FIG. 7 is time 710 along a horizontal axis and frames 702, 704, and 706. Frames 702 and 704 are transmitted by TX1 and frame 704 is transmitted by RX1. TX1 and RX1 are wireless devices 202. The wireless device 202 may signal information for spatial reuse in a separate frame exchange. For example, wireless device 202.4 may exchange a frame with wireless device 202.2 that includes the spatial reuse indication 506. The TX2 may be a wireless device 202. At time 608 TX2 may identify the spatial reuse opportunity after receiving the spatial reuse indication 506.

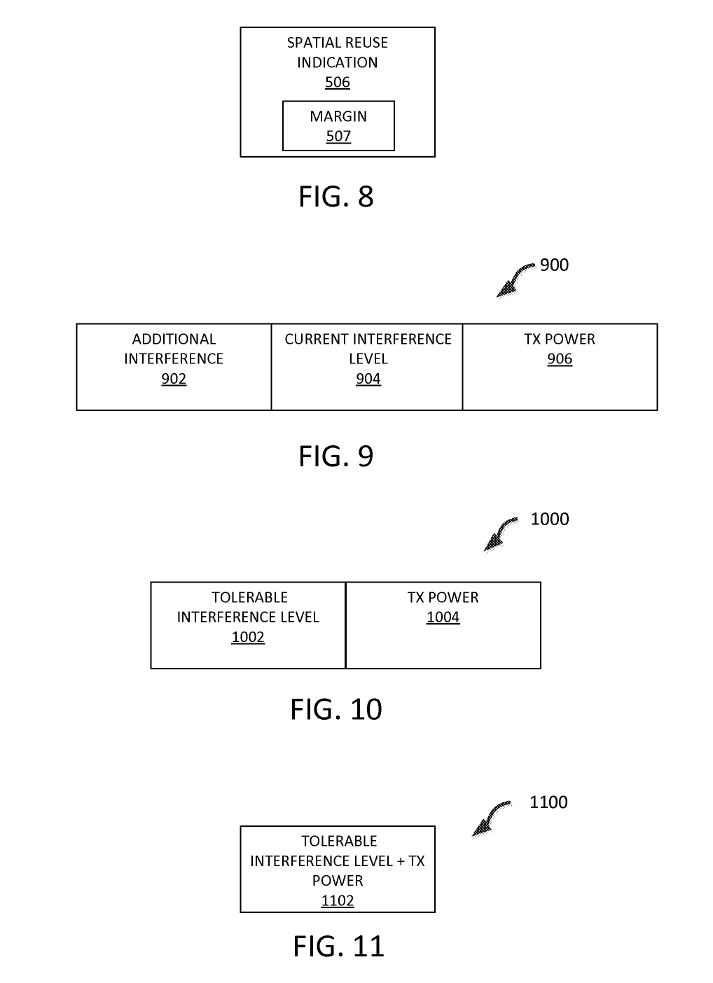

FIG. 8 illustrates a spatial reuse indication 506 that comprises a margin 507 field in accordance with some embodiments. FIG. 8 will be described in conjunction with FIGS. 9-14. FIGS. 9-11 illustrate margin 900, 1000, 1100 fields, respectively, in accordance with some embodiments.

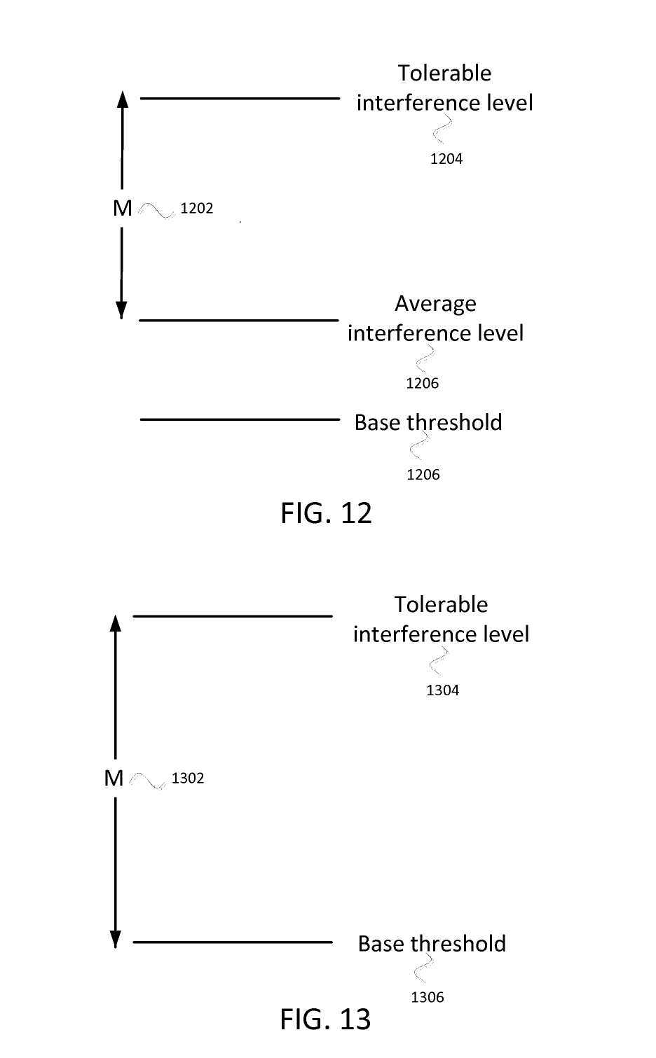

FIG. 9 illustrates a margin 900 field that includes additional interference 902 subfield, current interference level 904 subfield, and TX power 906 subfield. The additional interference 902 may be additional interference 1202 as described in conjunction with FIG. 12. The current interference level 904 may be a current or average interference level 1206 as described in conjunction with FIG. 12. The TX power 906 subfield may be the TX power 906 of the transmitter of the margin 900 field.

FIG. 10 illustrates a margin 1000 field that includes tolerable interference level 1002 subfield and TX power 1004 subfield. The tolerable interference level 1002 subfield may be a tolerable interference level 1302 as described in conjunction with FIG. 13. The TX power 1004 may be the TX power of the transmitter of the margin 1000 field.

FIG. 11 illustrates a margin 1100 field that includes a tolerable interference level plus TX power 1102 subfield. The tolerable interference level may be a tolerable interference level 1302 as described in conjunction with FIG. 13. The TX power may be the transmit power of the transmitter of the margin 1100 field.

FIG. 12 illustrates the margin 1202 as an additional interference above an average interference level 1206. Illustrated in FIG. 12 are M 1202, tolerable interference level 1204, average interference level 1206, and base threshold 1206. M 1202 is the margin. The average interference level 1206 may be an average amount of interference the TX has been experiencing. The average interference level 1206 may be determined based on feedback from the RX such as wireless device 202.6 (FIGS. 2 and 3). The tolerable interference level 1204 may be an amount of interference the TX determines the TX can tolerate. In some embodiments, the tolerable interference level may be based on a MCS level. For example, the tolerable interference level 1204 may be an interference level that if reached or surpassed would mean the TX would switch to a lower MCS level. M 1202 may be the margin or amount of additional interference the TX may receive before reaching the tolerable interference level 1204.

FIG. 13 illustrates the margin 1302 as a tolerable interference level 1304 above a base threshold 1306. The base threshold 1306 may be a known threshold value. The tolerable interference level 1304 may be determined by the TX such as wireless device 202.5 (FIG. 3) based on the TX's characteristics and/or recent communications of the TX. The tolerable interference level 1304 may be a known tolerable interference level 1304 for a particularly MCS the TX is using or intends to use. The margin (M) 1302 may indicate an additional interference that can be tolerated by the TX above the base threshold 1306.

In some embodiments, the value of margin (M) 507, 900, 1000, 1100, 1202, and 1302 may be signaled with 5 bits to indicate a value from 0 to 31 dB with 1 dB increments. In some embodiments, the value of M 507, 900, 1000, 1100, 1202, and 1302 may be signaled with 4 bits to indicate a value from 0 to 30 dB with 2 dB increments. In some embodiments, some bits may indicate a base and some bits may indicate a multiplier such as M=base * multiplier. For example, 3 bits may be used to indicate a base from 0 to 7 and 2 bits may be used to indicate a multiplier where the multiplier may be one plus the binary number represented by the multiplier bits. In some embodiments, if a bit is used to indicate whether or not a D2D spatial reuse opportunity is available, the bits for the value of M 507, 900, 1000, 1100, 1202, and 1302 may be ignored or absent if the bit indicates there is not a D2D spatial reuse opportunity.

The TX power 906, 1004 may be represented as a predefined unit. For example, 10 may indicate 10 mW. The TX power 906, 1004 may be represented based on a predefined unit and base. For example, 10 may indicate (10+base) mW, where the base may be a number such as 20. The TX power 906, 1004 may be represented based on a predefined unit and a relative value. For example, 10 may mean 10 dB compared to 1 mW, which would give 10 mW. In some embodiments, the TX power 906, 1004 may be determined by the master station 102. In some embodiments, the transmit power may be determined by the wireless protocol such as IEEE 802.11ax.

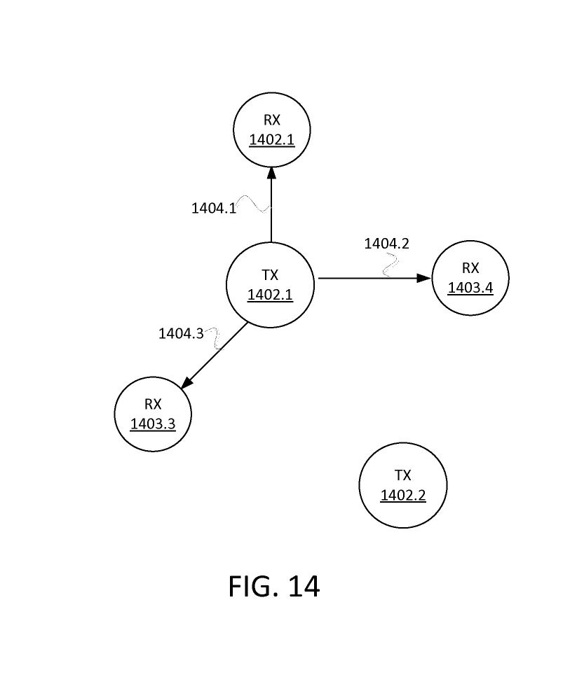

FIG. 14 illustrates a TX wireless device 1402.1 with three RX wireless devices 1403 linked to the TX wireless device 1402.1 in accordance with some embodiments. RX wireless devices 1403 may be wireless devices 202 that are receiving transmission from TX wireless device 1402.5. TX wireless device 1402.1 may be a wireless device 202 linked to RX wireless devices 1403. The links 1404.1, 1404.2, and 1404.3 may be links 204 as described in conjunction with FIGS. 2 and 3. TX 1402.2 may be a wireless device 202 that will spatially reuse at least some of the bandwidth used by TX wireless device 1402.1 and RX wireless devices 1403.4.

In some embodiments TX wireless device 1402.1 may signal one margin 507, 900, 1000, 1100, 1202, and 1302 for multiple links 1404 such as links 1404.1, 1404.2, and 1404.3. The wireless device 202 such as TX wireless device 1402.1 may signal the minimum margin 507, 900, 1000, 1100, 1202, and 1302 among all the RX wireless devices 1403 linked 1404 to the TX wireless device 1402.

For example, if M_{J} is the margin 507, 900, 1000, 1100, 1202, 1302 for link 1404 J, then the wireless device 202 may determine the M_{J} for each link 1404 J to the TX wireless device 1402.1, and select the J with the minimum margin 507, 900, 1000, 1100, 1202, 1302 and transmit A as the margin 507, 900, 1000, 1100, 1202, 1302.

For margin 900, the TX wireless device 1402.1 may determine tolerated interference levels of all links (TI)=minimum (M_{J}+I_{J}), where J is considered for all the links 1404 from 1 to the number of links 1404, A is the margin for link J, and I_{J} may be the interference of link J. In FIG. 12, M is M 1202 and I is average interference level 1206. The TX wireless device 1402.1 would then set additional interference 902 to A (M 1202) and current interference level 904 to I_{J} (average interference level 1206.)

For margin 1000, the TX wireless device 1402.1 will set tolerable interference level 1002 to the minimum of M_{J} where M_{J} is M 1302. For margin 1100, the TX wireless device 1402.1 will set tolerable interference level 1002 to the minimum of A where A is M 1302 plus the TX power of TX wireless device 1402.1.

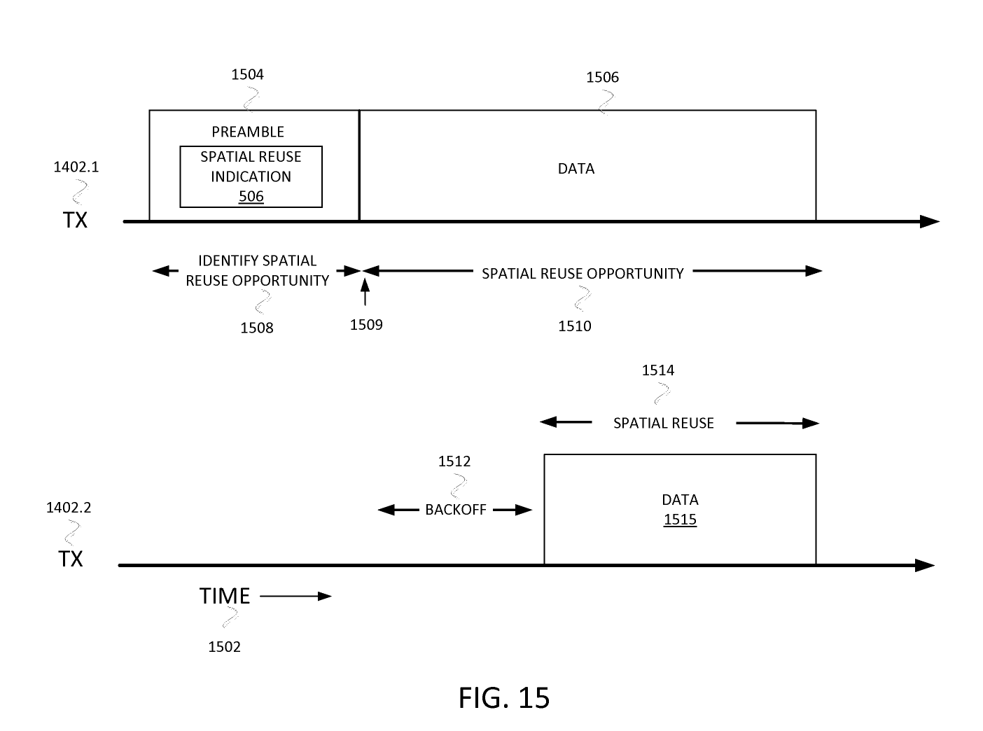

The method 400 may continue at operation 406 with spatially reuse a sub-channel. Operation 406 is described in conjunction with FIG. 15. FIG. 15 illustrates a method of spatial reuse in accordance with some embodiments.

Illustrated in FIG. 15 is time 1502 along a horizontal axis and the transmitter along the vertical axis. The transmitter TX 1402.1 transmits on a sub-channel a first portion of the packet 1504 which may include a spatial reuse indication 506. In some embodiments the spatial reuse indication 506 may have been transmitted in a previous packet as described in conjunction with FIGS. 6 and 7. TX 1402.1 may transmit data 1506 which may be a packet such as data or another type of packet.

TX 1402.2 may receive the preamble 1504 and may identify a spatial reuse opportunity 1510 based on the preamble 1404, or as described in conjunction with FIGS. 6 and 7 from a previous packet. The TX2 1402.2 may not be able to identify the spatial reuse opportunity 506 until time 1509. At time 1509 the TX 1402.2 may have received the preamble 1504 and determined that a spatial reuse opportunity 1510 exits. The spatial reuse opportunity 506 may be a duration that is based on the time to transmit packet 1506 and may be the same sub-channel or a portion of the sub-channel in use by TX 1402.1.

TX 1402.2 may then backoff 1512 in accordance with IEEE 802.11 communications protocol. In some embodiments, TX 1402.2 may adjust the size of the backoff 1112 or may not backoff 1112. TX2 802.2 may adjust the transmission power or CCA parameters, which may be based on information in the spatial reuse indication 506 such as margin 507, 900, 1000, 1100. For example, for a margin 1000 (FIG. 10), TX 1402.2 may set the transmission power to interference 206.7 (FIG. 2)+the current transmission power−tolerable interference 1002−TX power 1004. As another example, for a margin 1100 (FIG. 11), TX 1402.2 may set the transmission power to the transmission power to interference 206.7+the current transmission power−tolerable interference level+TX power 1102.

TX 1402.2 may then transmit data 1515 during the spatial reuse 1514. Data 1515 may be a packet. Spatial reuse 1514 may extend past spatial reuse opportunity 1510 in accordance with some embodiments. Data 1515 may end before the end of the spatial reuse opportunity 1510. TX 1402.2 may only utilize the spatial reuse opportunity 1510 links 1404 are D2D links.

TX 1402.2 may ignore a medium busy condition if it uses another mechanism to determine if there are additional gains and TX 1402.2 does not affect existing transmissions. TX 1402.2 may adjust the window size for backoff 1412 prior to performing a backoff 1412. The window size may be based on the spatial reuse indication 506. The window size may be only for the spatial reuse opportunity 1510 and TX 1402.2 may revert to the previous window size after the spatial reuse opportunity 1510. In some embodiments, TX 1402.2 may not reset the window size after the data 1515 transmission to insure that other devices have a fair opportunity to use the sub-channel or wireless medium.

In some embodiments, a receiver of data 1515 may perform adjustments to CCA and/or the power transmission level for the spatial reuse opportunity 1510 based on control frames received from TX 1402.2. In some embodiments, a receiver of the data 1515 may ignore the network allocation vector (NAV) and respond to control frames from TX 1402.2 such as a CTS for spatial reuse.

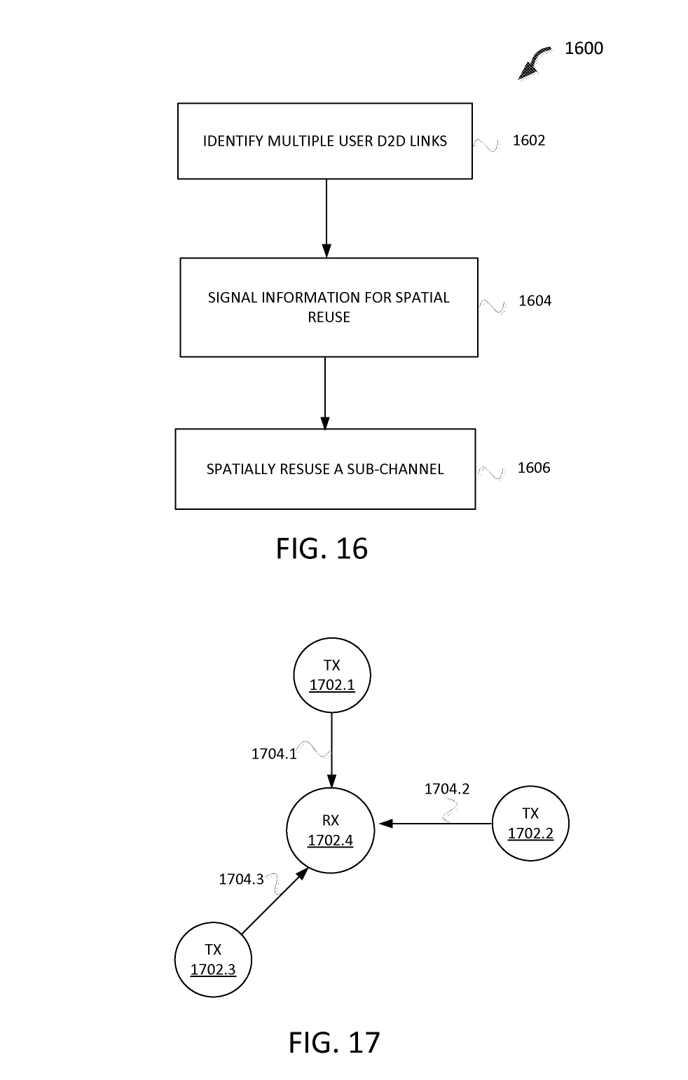

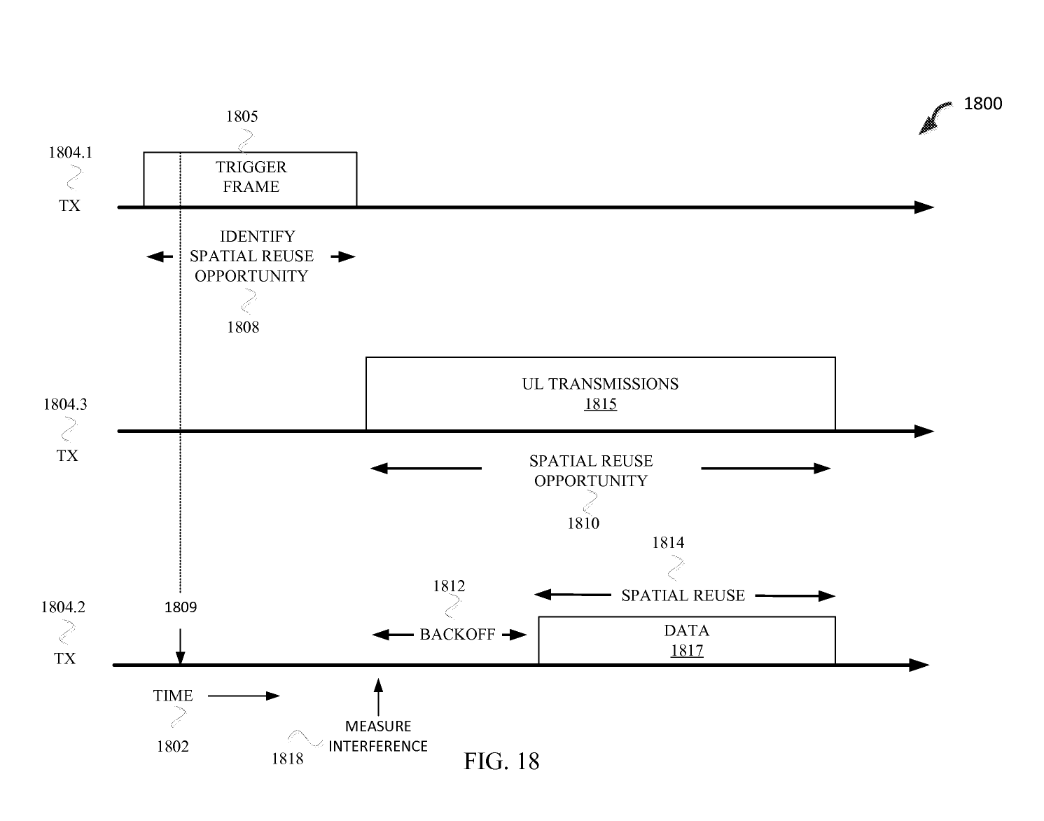

FIG. 16 illustrates a method 1600 for uplink spatial reuse in accordance with some embodiments. FIG. 16 will be described in conjunction with FIGS. 17 and 18. Method 1600 may be for spatial reuse of a bandwidth during an uplink OFDMA/MU-MIMO period or transmission opportunity that may be initiated by a trigger frame 1805 for D2D links. For example, the UL transmissions 1815 may present a spatial reuse opportunity 1810.

The method begins at operation 1602 with identify multiple user D2D links. D2D links are identified so that another link can potentially spatially reuse the same or an overlapping sub-channel or channel. The D2D links may be identified as described in conjunction with FIG. 4. In some embodiments, the receiver may identify the D2D opportunities rather than the transmitter which may save the feedback signaling form the receiver. FIG. 17 illustrates an example where a receiver may identify the D2D links in accordance with some embodiments. RX wireless device 1702.4 and TX wireless devices 1702.1, 1702.2, and 1702.3 may be wireless devices 202. TX 1702.4 may be a master station 102 that may have transmitted trigger frame 1805 to the TX wireless devices 1702.1, 1702.2, and 1702.3, and the TX wireless devices 1702.1, 1702.2, 1702.3 may be transmitting UL transmissions 1815 to the master station 102. The links 1704.1, 1704.2, 1704.3 may be D2D links. The RX wireless device 1702.4 may determine that the links 1704.1, 1704.2, 1704.3 are D2D links based on received signals such as previous UL transmissions 1815 or other transmissions such as association transmissions from the TX wireless devices 1702.1, 1702.2, 1702.3.

The method 1600 may continue at operation 1604 with signal a spatial reuse indication 506 in accordance with some embodiments. The wireless device 202 may signal the spatial reuse indication 506 as described in conjunction with FIG. 4. In some embodiments the wireless device 202 such as RX wireless device 1702.4 may signal the spatial reuse indication in a trigger frame 1805. For example, the trigger frame 1805 may comprise PHY/MAC signaling for the spatial reuse indication 506. The trigger frame 1805 may use a MAC portion if a legacy preamble is used. The trigger frame 1805 may signal a MCS selection and transmission power for uplink stations, so that the master station 102 may be able to choose the right margin for spatial reuse signaling.

The method 1600 may continue at operation 1606 with spatially reuse a sub-channel. Operation 1606 is described in conjunction with FIGS. 17 and 18.

FIG. 18 illustrates a method 1800 for uplink spatial reuse in accordance with some embodiments. TX wireless device 1804.2, TX wireless device 1804.3, and TX wireless device 1804.1 may be wireless devices 202. TX wireless device 1804.1 may be RX wireless device 1702.4 (FIG. 17). TX wireless device 1804.2 is not illustrated in FIG. 17. TX wireless device 1804.3 may be TX wireless devices 1702.1, 1702.2, 1702.3. The trigger frame 1805 may be a trigger frame 1805 that indicates resources for the TX wireless devices 1804.3 to use to transmit in the uplink to the TX wireless device 1804.1. The UL transmissions 1815 may be the TX wireless devices 1804.3 transmitting data to the TX wireless device 1804.1 in response to the trigger frame 1805. The data 1817 may TX wireless device 1804.2 transmitting data 1817 in a spatial reuse 1814 in a spatial reuse opportunity 1810. Backoff 1812 may be a time period where TX wireless device 1804.2 contends for the wireless medium.

TX wireless device 1804.2 may determine that a spatial reuse opportunity 1810 exists based on the trigger frame 1805. For example, at time 1809 the TX wireless device 1804.2 may have received the spatial reuse indication 506 from a HE PHY header. The TX wireless device 1804.2 may have to receive the entire trigger frame 1805 to receive the spatial reuse indication 506 in a MAC portion of the trigger frame 1805.

The trigger frame 1805 as part of the resource allocation includes a duration for the transmission opportunity. The TX wireless device 1804.2 may then determine the duration of the spatial reuse opportunity 1810 from the trigger frame 1805. The TX wireless device 1804.2 may also determine the start time of the spatial reuse opportunity 1810 from the trigger frame 105.

The TX wireless device 1804.2 may transmit data 1817 during the spatial reuse opportunity 1810. In some embodiments the TX wireless device 1804.2 may extend the time to transmit data 1817 past the spatial reuse opportunity 1810. In some embodiments the TX wireless device 1804.2 may not backoff 1812 and may transmit data 1817 at the start of the spatial reuse opportunity 1810. In some embodiments the TX wireless device 1804.2 may measure the interference 1818 and determine whether to transmit or not based on the interference.

In some embodiments spatial reuse opportunity 1810 may be for a MU-MIMO uplink. In some embodiments spatial reuse opportunity 1810 may be for a MU-MIMO downlink. In some embodiments spatial reuse opportunity 1810 may be for an OFDMA downlink.

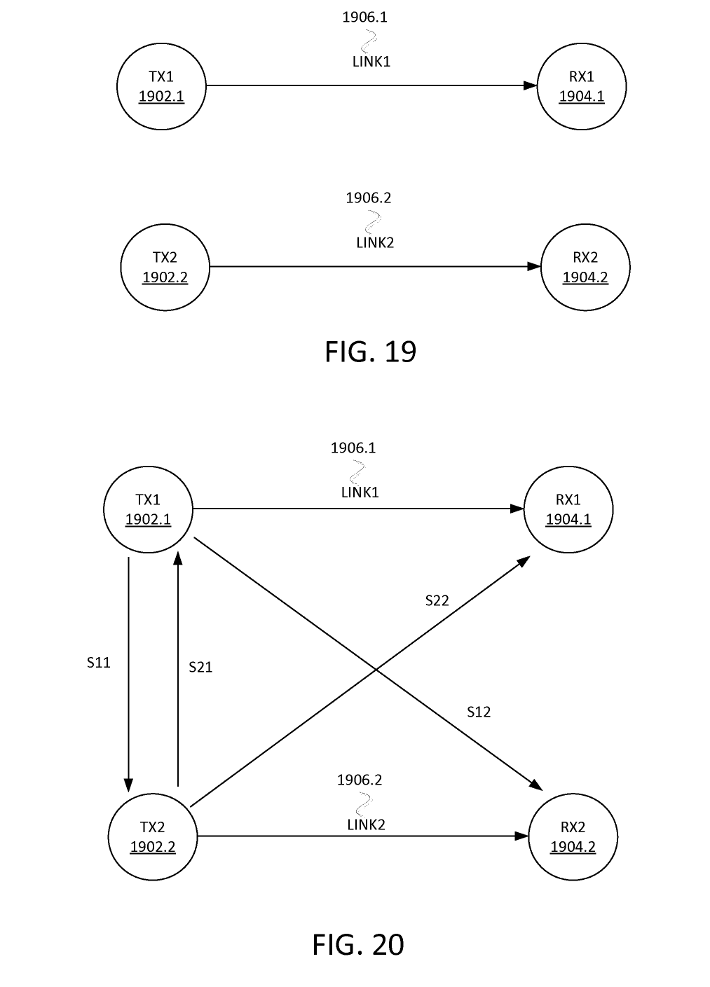

FIG. 19 illustrates two links 1906 in accordance with some embodiments. TX1 1902.1, TX2 1902.2, RX1 1904.1, and RX2 1904.2 may be wireless devices 202. Link1 1906.1 and link2 1906.2 may be links 206 between TX1 1902.1, TX2 1902.2, and RX1 1904.1, RX2 1904.2, respectively. Link1 1906.1 and link2 1906.2 may be D2D links. FIGS. 12 and 13 illustrate margins 1202, 1302 in accordance with some embodiments.

FIG. 20 illustrates the two links 1906 illustrated in FIG. 19 with signal strengths in accordance with some embodiments. S11 is the signal strength from TX1 1902.1 to TX2 1902.2. S12 is the signal strength from TX1 1902.1 to RX2 1904.2. S21 is the signal strength from TX2 1902.2 to TX1 1902.1. S22 is the signal strength from TX2 1902.2 to RX1 1904.1. As described in conjunction with FIG. 17 TX1 1902.1 may determine the link1 1906.1

When TX2 1902.2 receives the preamble 1504 or trigger frame 1805 from TX1 1902.1, the signal strength is S11. If the power difference between TX1 1902.1 and TX2 1902.2 is D=P1−P2, then the signal strength S21 is S11-D, where P1 is the transmission power of TX1 1902.1 and P2 is the transmission power of TX2 1902.2. In some embodiments, since link1 1906.1 is a D2D link, TX2 1902.2 may assume that TX1 1902.1 and RX1 1904.1 are close. RX1 804.1 may then assume that signal values S21 and S22 have values that are close to one another. TX2 1902.2 can then infer its signal strength S21 or interference to RX1 1904.1 based on the received signal strength S11. In some embodiments, TX2 1902.2 may approximate signal strength S22 as equal to signal strength S11 if link2 1906.2 is a D2D link.

TX2 1902.2 may adjust its power transmission for the spatial reuse 1514, 1814 in some embodiments as follows. TX2 1902.2 receives M 507 in the spatial reuse indication 506. TX2 1902.2 may estimate signal strength S21 as S11-D, where D is the power difference between TX1 1902.1 and TX2 1902.2. TX2 1902.2 may estimate the additional interference above M of RX1 1904.1 as A=S21−M=S11−D−M=S11−(P1−P2)−M. TX2 1902.2 may reduce power to some value larger than A+K, if A+K>0, where K can be a constant. TX2 1902.2 may select a MCS based on the final transmission power and the average interference reported by RX2 1904.2. TX2 1902.2 may reduce the transmission power only for the spatial reuse 1514, 1814.

TX2 1902.2 may adjust its power transmission for the spatial reuse 1514, 1814 in some embodiments as follows. TX2 1902.2 may use a known threshold L for HEW stations 104 or wireless device 202. L may be determined by a communication protocol and may be predefined. TX2 1902.2 may receive M 507 in the spatial reuse indication 1514, 1814. M 507 may be equal to tolerable interference-(L−P1) rather than M being equal to tolerable interference. TX2 1902.2 may estimate S21=S11−(L−P2) rather than S21=S11−D. TX2 1902.2 may estimate the additional interference above the tolerable interference of RX1 1904.1 as A=S21−M=S11−(L−P2)−tolerable interference+(L−P1)=S11−(P1−P2)−tolerable interference. TX2 1902.2 may reduce power to some value larger than A+K, if A+K>0, where K can be a constant. TX2 1902.2 may select a MCS based on the final transmission power and the average interference reported by RX2 1904.2. TX2 1902.2 may reduce the transmission power only for the spatial reuse 1514, 1814.

In some embodiments, TX2 1902.2 may adjust the CCA as follows. TX2 1902.2 may determine the additional interference that RX1 1904.1 can tolerate by using M 507 transmitted by TX1 1902.1 and based on link1 1906.1 being a D2D link. TX2 1902.2 may only use the spatial reuse opportunity 1514, 1814 if link2 1906.2 is also a D2D link. TX2 1902.2 may increase CCA by M-D, where D is the transmission power difference between TX1 1902.1 and TX2 1902.2. TX2 1902.2 may select a MCS based on the final transmission power and the average interference reported by RX2 1904.2. In some embodiments, TX2 1902.2 may increase CCA only for the spatial reuse 1514, 1814.

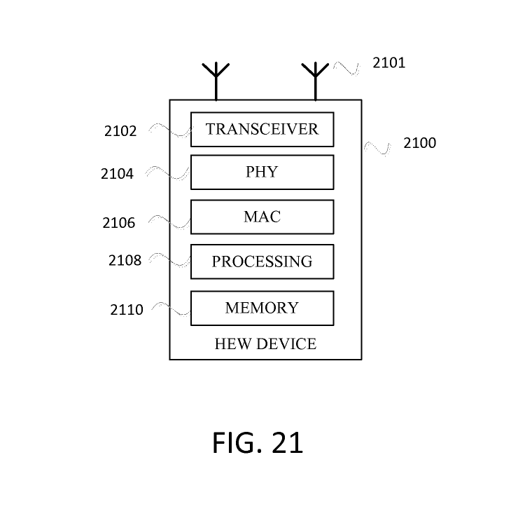

FIG. 21 illustrates a HEW device in accordance with some embodiments. HEW device 2100 may be an HEW compliant device that may be arranged to communicate with one or more other HEW devices, such as HEW STAs 104 (FIG. 1) or master station 102 (FIG. 1) as well as communicate with legacy devices 106 (FIG. 1). HEW STAs 104 and legacy devices 106 may also be referred to as HEW devices and legacy STAs, respectively. HEW device 2100 may be suitable for operating as master station 102 (FIG. 1) or a HEW STA 104 (FIG. 1). In accordance with embodiments, HEW device 2100 may include, among other things, a transmit/receive element 2101 (for example an antenna), a transceiver 2102, physical (PHY) circuitry 2104, and media access control (MAC) circuitry 2106. PHY circuitry 2104 and MAC circuitry 2106 may be HEW compliant layers and may also be compliant with one or more legacy IEEE 802.11 standards. MAC circuitry 2106 may be arranged to configure packets such as a physical layer convergence procedure (PLCP) protocol data unit (PPDUs) and arranged to transmit and receive PPDUs, among other things. HEW device 2100 may also include circuitry 2108 and memory 2110 configured to perform the various operations described herein. The circuitry 2108 may be coupled to the transceiver 2102, which may be coupled to the transmit/receive element 2101. While FIG. 21 depicts the circuitry 2108 and the transceiver 2102 as separate components, the circuitry 2108 and the transceiver 2102 may be integrated together in an electronic package or chip.

In some embodiments, the MAC circuitry 2106 may be arranged to contend for a wireless medium during a contention period to receive control of the medium for the HEW control period and configure an HEW PPDU. In some embodiments, the MAC circuitry 2106 may be arranged to contend for the wireless medium based on channel contention settings, a transmitting power level, and a CCA level.

The PHY circuitry 2104 may be arranged to transmit the HEW PPDU. The PHY circuitry 2104 may include circuitry for modulation/demodulation, upconversion/downconversion, filtering, amplification, etc. In some embodiments, the circuitry 2108 may include one or more processors. The circuitry 2108 may be configured to perform functions based on instructions being stored in a RAM or ROM, or based on special purpose circuitry. The circuitry 2108 may be termed processing circuitry in accordance with some embodiments. The circuitry 2108 may include a processor such as a general purpose processor or special purpose processor. The circuitry 2108 may implement one or more functions associated with transmit/receive elements 2101, the transceiver 2102, the PHY circuitry 2104, the MAC circuitry 2106, and/or the memory 2110.

In some embodiments, the circuitry 2108 may be configured to perform one or more of the functions and/or methods described herein and/or in conjunction with FIGS. 1-21 such as, for example, such as generating, transmitting, receiving, and operating in accordance with signaling for a spatial reuse. Additionally, the master station 102 and/or HEW device 104 may be configured to encode additional format or configuration information in the MCS field and/or using tail bits.

In some embodiments, the transmit/receive elements 1201 may be two or more antennas that may be coupled to the PHY circuitry 1204 and arranged for sending and receiving signals including transmission of the HEW packets. The transceiver 1202 may transmit and receive data such as HEW PPDU and packets that include an indication that the HEW device 1200 should adapt the channel contention settings according to settings included in the packet. The memory 1210 may store information for configuring the other circuitry to perform operations for configuring and transmitting HEW packets and performing the various operations to perform one or more of the functions and/or methods described herein and/or in conjunction with FIGS. 1-21 such as, for example, such as generating, transmitting, receiving, and operating in accordance with signaling for a spatial reuse. Additionally, the master station 102 and/or HEW device 104 may be configured to encode additional format or configuration information in the MCS field and/or using tail bits.

In some embodiments, the HEW device 2100 may be configured to communicate using OFDM communication signals over a multicarrier communication channel. In some embodiments, HEW device 2100 may be configured to communicate in accordance with one or more specific communication standards, such as the Institute of Electrical and Electronics Engineers (IEEE) standards including IEEE 802.11-2012, 802.11n-2009, 802.11ac-2013, 802.11ax, or anther standard such as one or more of the standards disclosed in conjunction with FIG. 1. DensiFi, standards and/or proposed specifications for WLANs, or other standards as described in conjunction with FIG. 1, although the scope of the invention is not limited in this respect as they may also be suitable to transmit and/or receive communications in accordance with other techniques and standards. In some embodiments, the HEW device 2100 may use 4× symbol duration of 802.11n or 802.11ac.

In some embodiments, an HEW device 2100 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as 802.11 or 802.16, or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be an LCD screen including a touch screen.

The transmit/receive element 2101 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Although the HEW device 2100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The following examples pertain to further embodiments. Example 1 is an apparatus of a high-efficiency (HE) wireless local area network (HEW) station, including circuitry configured to: determine if a plurality of links with a plurality of wireless stations are device-to-device links that indicate that there is a spatial reuse opportunity; and transmit a packet that comprises a spatial reuse indication that there is the spatial reuse opportunity, if the spatial reuse opportunity is indicated.

In Example 2, the subject matter of Example 1 can optionally include where the packet is one from the following group: a management frame, a data frame, and a trigger frame.

In Example 3, the subject matter of Examples 1 or 2 can optionally include where the spatial reuse opportunity is at least one from the following group: an uplink orthogonal frequency division multiple access (OFDMA) with the plurality of wireless stations, a downlink OFDMA with the plurality of wireless stations, and a downlink multiple users multiple-input multiple-output (MU-MIMO).

In Example 4, the subject matter of any of Examples 1-3 can optionally include where the circuitry is further configured to: transmit a trigger frame to the plurality of wireless stations; in response to the trigger frame, receive data from each of the plurality of wireless stations in accordance with uplink orthogonal frequency division multiple access (OFDMA); and determine the plurality of links with the plurality of wireless stations are the D2D links that indicate the spatial reuse opportunity based on the signals transmitted in response to the trigger frame from the plurality of wireless stations.

In Example 5, the subject matter of any of Examples 1-4 can optionally include where the spatial reuse indication includes a margin that indicates at least one of the following group: an additional interference that can be tolerated by the HEW station, current interference level, and a transmit power of the HEW station; a tolerable interference level and the transmit power of the HEW station; and, a tolerable interference level plus the transmit power of the HEW station.

In Example 6, the subject matter of any of Examples 1-5 can optionally include where the circuitry is further configured to: determine a link with a lowest margin of the plurality of links, and wherein the spatial reuse indication includes the lowest margin.

In Example 7, the subject matter of Example 6 can optionally include where the lowest margin indicates at least one of the following group: an additional interference that can be tolerated by a corresponding wireless station of the link, a current interference level of the link, and a transmit power of the corresponding wireless station of the plurality of wireless stations; a tolerable interference level and the transmit power of the corresponding wireless station of the plurality of wireless stations; and, a tolerable interference level plus the transmit power of the corresponding wireless station of the plurality of wireless stations.

In Example 8, the subject matter of any of Examples 1-7 can optionally include where the spatial reuse indication includes a margin that indicates at least one of the following group: additional interference, current interference level, transmit power, and tolerable interference level.

In Example 9, the subject matter of any of Examples 1-9 can optionally include where the HEW station is a master station, and wherein the signals are received in response to a trigger frame transmitted by the HEW station.

In Example 10, the subject matter of any of Examples 1-9 can optionally include where the circuitry is further configured to: receive an indication from one or more of the plurality of wireless stations that the corresponding link of the plurality of links is a device-to-device link; and determine the plurality of links with the plurality of wireless stations are device-to-device links based on the indication from the one or more of the plurality of wireless stations.

In Example 11, the subject matter of any of Examples 1-10 can optionally include where the circuitry is further configured to transmit in accordance with at least one from the following group: orthogonal frequency division multiple access (OFDMA) and multiple-user multiple input and output (MU-MIMO).

In Example 12, the subject matter of any of Examples 1-11 can optionally include where the spatial reuse indication is to be transmitted in at least one from the following group: a HE signal (SIG) preamble and media access control (MAC) of the packet.

In Example 13, the subject matter of any of Examples 1-12 can optionally include where the plurality of wireless stations are each one from the following group: a legacy device, a second HEW station, and a master station.

In Example 14, the subject matter of any of Examples 1-13 can optionally include where the circuitry further includes processing circuitry and transceiver circuitry.

In Example 15, the subject matter of Example 14 can optionally include memory and a transceiver coupled to the circuitry; and, one or more antennas coupled to the transceiver.

Example 16 is a method performed by a high-efficiency (HE) wireless local area network (WLAN) (HEW) device. The method including determining if a plurality of links with a plurality of wireless stations are device-to-device links that indicate that there is a spatial reuse opportunity; and transmitting a packet that comprises a spatial reuse indication that there is the spatial reuse opportunity, if the spatial reuse opportunity is indicated.

In Example 17, the subject matter of Example 16 can optionally include where the spatial reuse opportunity is at least one from the following group: an uplink orthogonal frequency division multiple access (OFDMA) with the plurality of wireless stations, a downlink OFDMA with the plurality of wireless stations, and a downlink multiple users multiple-input multiple-output (MU-MIMO).

In Example 18, the subject matter of Examples 16 and 17 can optionally include where the method further comprises: transmitting a trigger frame to the plurality of wireless stations; receiving data from each of the plurality of wireless stations in accordance with uplink orthogonal frequency division multiple access (OFDMA) in response to the trigger frame; and determining the plurality of links with the plurality of wireless stations are the D2D links that indicate the spatial reuse opportunity based on the signals transmitted in response to the trigger frame from the plurality of wireless stations.

In Example 19, the subject matter of any of Examples 16-18 can optionally include where the spatial reuse indication includes a margin that indicates at least one of the following group: an additional interference that can be tolerated by the HEW station, current interference level, and a transmit power of the HEW station; a tolerable interference level and the transmit power of the HEW station; and, a tolerable interference level plus the transmit power of the HEW station.

Example 20 is an apparatus of a high-efficiency (HE) wireless local area network (HEW) station. The apparatus including circuitry configured to: receive a packet from a second HEW station, wherein the packet includes an indication that there is a spatial opportunity; adjust at least one of the following group: a transmit power and a clear channel assessment; and transmit one or more packets to each of a plurality of wireless devices within the spatial opportunity in accordance with device-to-device communication in accordance with orthogonal frequency division multiple access (OFDMA).

In Example 21, the subject matter of Example 20 can optionally include where the indication includes an indication of how much additional interference can be tolerated within the spatial opportunity, and wherein the circuitry is further configured to reduce the transmit power of the HEW STA based on the indication of how much additional interference can be tolerated within the spatial opportunity.

In Example 22, the subject matter of Examples 20 and 21 can optionally include where the indication includes an indication of how much additional interference can be tolerated within the spatial opportunity, and where the circuitry is further configured to increase a signal detect level of the clear channel assessment based on the indication of how much additional interference can tolerate within the spatial opportunity, and where the circuitry is further configured to perform a mid-packet detect to determine if a wireless medium is busy.

In Example 23, the subject matter of any of Examples 20-22 can optionally include memory and a transceiver coupled to the circuitry; and one or more antennas coupled to the transceiver.

Example 24 is a non-transitory computer-readable storage medium that stores instructions for execution by one or more processors of a high-efficiency (HE) wireless local-area network (WLAN) (HEW) master station, the operations to configure the one or more processors to cause the HEW master station to: determine if a plurality of links with a plurality of wireless stations are device-to-device links that indicate that there is a spatial reuse opportunity; and transmit a packet that comprises a spatial reuse indication that there is the spatial reuse opportunity, if the spatial reuse opportunity is indicated.

In Example 25, the subject matter of Example 24 can optionally include where the one or more processors are further configured to cause the HEW master station to: determine a link with a lowest margin of the plurality of links, and wherein the spatial reuse indication includes the lowest margin, and wherein the lowest margin indicates at least one of the following group: an additional interference that can be tolerated by a corresponding wireless station of the link, a current interference level of the link, and a transmit power of the corresponding wireless station of the plurality of wireless stations; a tolerable interference level and the transmit power of the corresponding wireless station of the plurality of wireless stations; and, a tolerable interference level plus the transmit power of the corresponding wireless station of the plurality of wireless stations.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a high-efficiency (HE) wireless local area network (HEW) station, comprising circuitry configured to:
determine if a plurality of links with a plurality of wireless stations are device-to-device links that indicate that there is a spatial reuse opportunity; and
transmit a packet that comprises a spatial reuse indication that there is the spatial reuse opportunity, if the spatial reuse opportunity is indicated.

2. The apparatus of the HEW station of claim 1, wherein the packet is one from the following group: a management frame, a data frame, and a trigger frame.

3. The apparatus of the HEW station of claim 1, wherein the spatial reuse opportunity is at least one from the following group: an uplink orthogonal frequency division multiple access (OFDMA) with the plurality of wireless stations, a downlink OFDMA with the plurality of wireless stations, and a downlink multiple users multiple-input multiple-output (MU-MIMO).

4. The apparatus of the HEW station of claim 1, wherein the circuitry is further configured to:
transmit a trigger frame to the plurality of wireless stations;
in response to the trigger frame, receive data from each of the plurality of wireless stations in accordance with uplink orthogonal frequency division multiple access (OFDMA); and
determine the plurality of links with the plurality of wireless stations are the D2D links that indicate the spatial reuse opportunity based on the signals transmitted in response to the trigger frame from the plurality of wireless stations.

5. The apparatus of the HEW station of claim 1, wherein the spatial reuse indication includes a margin that indicates at least one of the following group: an additional interference that can be tolerated by the HEW station, current interference level, and a transmit power of the HEW station; a tolerable interference level and the transmit power of the HEW station; and, a tolerable interference level plus the transmit power of the HEW station.

6. The apparatus of the HEW station of claim 1, wherein the circuitry is further configured to:
determine a link with a lowest margin of the plurality of links, and wherein the spatial reuse indication includes the lowest margin.

7. The apparatus of the HEW station of claim 6, wherein the lowest margin indicates at least one of the following group: an additional interference that can be tolerated by a corresponding wireless station of the link, a current interference level of the link, and a transmit power of the corresponding wireless station of the plurality of wireless stations; a tolerable interference level and the transmit power of the corresponding wireless station of the plurality of wireless stations; and, a tolerable interference level plus the transmit power of the corresponding wireless station of the plurality of wireless stations.

8. The apparatus of the HEW station of claim 1, wherein the spatial reuse indication includes a margin that indicates at least one of the following group: additional interference, current interference level, transmit power, and tolerable interference level.

9. The apparatus of the HEW station of claim 1, wherein the HEW station is a master station, and wherein the signals are received in response to a trigger frame transmitted by the HEW station.

10. The apparatus of the HEW station of claim 1, wherein the circuitry is further configured to:
receive an indication from one or more of the plurality of wireless stations that the corresponding link of the plurality of links is a device-to-device link; and
determine the plurality of links with the plurality of wireless stations are device-to-device links based on the indication from the one or more of the plurality of wireless stations.

11. The apparatus of the HEW station of claim 1, wherein the circuitry is further configured to transmit in accordance with at least one from the following group: orthogonal frequency division multiple access (OFDMA) and multiple-user multiple input and output (MU-MIMO).

12. The apparatus of the HEW station of claim 1, wherein the spatial reuse indication is to be transmitted in at least one from the following group: a HE signal (SIG) preamble and media access control (MAC) of the packet.

13. The apparatus of the HEW station of claim 1, wherein the plurality of wireless stations are each one from the following group: a legacy device, a second HEW station, and a master station.

14. The apparatus of the HEW station of claim 1, wherein the circuitry further comprises processing circuitry and transceiver circuitry.

15. The apparatus of the HEW station of claim 14, further comprising memory and a transceiver coupled to the circuitry; and, one or more antennas coupled to the transceiver.

16. A method performed by a high-efficiency (HE) wireless local area network (WLAN) (HEW) device, the method comprising:
determining if a plurality of links with a plurality of wireless stations are device-to-device links that indicate that there is a spatial reuse opportunity; and
transmitting a packet that comprises a spatial reuse indication that there is the spatial reuse opportunity, if the spatial reuse opportunity is indicated.

17. The method of claim 16, wherein the spatial reuse opportunity is at least one from the following group: an uplink orthogonal frequency division multiple access (OFDMA) with the plurality of wireless stations, a downlink OFDMA with the plurality of wireless stations, and a downlink multiple users multiple-input multiple-output (MU-MIMO).

18. The method of claim 16, wherein the method further comprises:
transmitting a trigger frame to the plurality of wireless stations;
receiving data from each of the plurality of wireless stations in accordance with uplink orthogonal frequency division multiple access (OFDMA) in response to the trigger frame; and
determining the plurality of links with the plurality of wireless stations are the D2D links that indicate the spatial reuse opportunity based on the signals transmitted in response to the trigger frame from the plurality of wireless stations.

19. The method of claim 16, wherein the spatial reuse indication includes a margin that indicates at least one of the following group: an additional interference that can be tolerated by the HEW station, current interference level, and a transmit power of the HEW station; a tolerable interference level and the transmit power of the HEW station; and, a tolerable interference level plus the transmit power of the HEW station.

20. An apparatus of a high-efficiency (HE) wireless local area network (HEW) station, the apparatus comprising circuitry configured to:
receive a packet from a second HEW station, wherein the packet includes an indication that there is a spatial opportunity;
adjust at least one of the following group: a transmit power and a clear channel assessment; and
transmit one or more packets to each of a plurality of wireless devices within the spatial opportunity in accordance with device-to-device communication in accordance with orthogonal frequency division multiple access (OFDMA).

21. The apparatus of claim 20, wherein the indication includes an indication of how much additional interference can be tolerated within the spatial opportunity, and wherein the circuitry is further configured to reduce the transmit power of the HEW STA based on the indication of how much additional interference can be tolerated within the spatial opportunity.

22. The apparatus of claim 20, wherein the indication includes an indication of how much additional interference can be tolerated within the spatial opportunity, and wherein the circuitry is further configured to increase a signal detect level of the clear channel assessment based on the indication of how much additional interference can tolerate within the spatial opportunity, and wherein the circuitry is further configured to perform a mid-packet detect to determine if a wireless medium is busy.

23. The apparatus of claim 20, further comprising memory and a transceiver coupled to the circuitry; and one or more antennas coupled to the transceiver.

24. A non-transitory computer-readable storage medium that stores instructions for execution by one or more processors of a high-efficiency (HE) wireless local-area network (WLAN) (HEW) master station, the operations to configure the one or more processors to cause the HEW master station to:
determine if a plurality of links with a plurality of wireless stations are device-to-device links that indicate that there is a spatial reuse opportunity; and
transmit a packet that comprises a spatial reuse indication that there is the spatial reuse opportunity, if the spatial reuse opportunity is indicated.

25. The non-transitory computer-readable storage medium of claim 24, wherein the one or more processors are further configured to cause the HEW master station to:
determine a link with a lowest margin of the plurality of links, and wherein the spatial reuse indication includes the lowest margin, and wherein the lowest margin indicates at least one of the following group: an additional interference that can be tolerated by a corresponding wireless station of the link, a current interference level of the link, and a transmit power of the corresponding wireless station of the plurality of wireless stations; a tolerable interference level and the transmit power of the corresponding wireless station of the plurality of wireless stations; and, a tolerable interference level plus the transmit power of the corresponding wireless station of the plurality of wireless stations.
